(19) United States
(12) Patent Application Publication
(10) Pub. No.: US 2018/0046383 A1
(43) Pub. Date: Feb. 15, 2018

(54) MOVEMENT OF FREQUENTLY ACCESSED DATA CHUNKS BETWEEN STORAGE TIERS

(71) Applicant: HEWLETT PACKARD ENTERPRISE DEVELOPMENT LP, Houston, TX (US)

(72) Inventor: Matthew Gates, Houston, TX (US)

(21) Appl. No.: 15/235,562

(22) Filed: Aug. 12, 2016

(51) Int. Cl. G06F 3/06

(52) U.S. Cl. CPC G06F 3/0611; G06F 3/0647; G06F 3/0644; G06F 3/0683

(57) ABSTRACT

Examples include movement of frequently accessed data chunks between storage tiers. Some examples include selection of a first data chunk residing in a first tier of storage, and insertion of a reference to the first data chunk into a data structure in response to a determination that the first data chunk is frequently accessed, where the data structure includes a list of frequently accessed data chunks. Some examples include movement of the first data chunk to a second tier of storage, which has higher performance than the first tier of storage, in response to it being determined that the reference to the first data chunk is stored in the data structure.

### BACKGROUND

In a datacenter computing environment, it may be inefficient to allocate storage on a device-by-device level. In order to more efficiently allocate storage among multiple datacenter users, the storage may be allocated by a method called thin provisioning. Thin provisioning provides a minimum amount of storage space to each user and flexibly allocates additional storage space to a user according of usage. Thin provisioned storage can consist of a number of heterogeneous storage devices, and a portion of storage space allocated to a user is not restricted to a certain storage device or type of storage device.

### BRIEF DESCRIPTION OF THE DRAWINGS

Certain examples are described in the following detailed description in reference to the following drawings.

FIGS. 1 through 4B illustrate example methods for moving frequently accessed data chunks to a storage device.

FIG. 5 illustrates an example system for storing access counts of data chunks.

FIGS. 6A through 6D illustrate example data structures for storing a list of frequently accessed data chunks.

FIG. 7 illustrates an example computing system for moving frequently accessed data chunks to a storage device.

### DETAILED DESCRIPTION

Datacenters and other distributed computing systems include a number of storage devices. In some distributed computing systems, not all of the storage devices are homogeneous. Among the heterogeneous storage devices, some may have higher performance than others. This performance may be measured by latency, throughput, IOPS (input/output operations per second), or any other appropriate metric or combination of metrics. A distributed computing system may wish to efficiently use the higher performing storage devices to reduce the overall time spent accessing storage.

In order to use the higher performance storage devices more efficiently, data stored in the higher performance storage devices may have characteristics that cause the higher performance storage devices to be more frequently used than any lower performance storage devices. For instance, the most frequently accessed data may be stored in the higher performance storage devices, resulting in the higher performance storage devices receiving a disproportionately large amount of the read and write requests. In such instances, the overall efficiency of the distributed computing system may be improved because of the improved latency and throughput of the higher performance storage devices. However, scaling a distributed computing system into a larger system may increase the computing and storage overhead associated with moving data between storage devices, which can reduce, or even counteract, the efficiencies associated with using the higher performance storage devices more frequently. Although in some instances the storage overhead is reduced by segmenting the data at a coarser resolution than a byte or word, a sufficiently large system may still incur significant storage overhead from moving these larger segments, called data chunks, between storage devices.

Some examples described herein provide for moving frequently accessed data chunks between storage devices, An example system may count the number of accesses for each of a number of data chunks using a probabilistic algorithm and first data structure, determine the most frequently accessed data chunks using a second data structure, and move data chunks between higher performance storage devices and lower performance storage devices based on the second data structure, For example, a distributed computing system may keep track of access counts for a number of data chunks using a count-min sketch. Upon receiving an indication when a data chunk is accessed, the count-min sketch uses hash functions to increment values associated with the access count of the accessed data chunk. By using the count-min sketch to keep track of access counts, the example distributed computing system uses a reduced memory footprint to store the access counts of the data chunks.

An example distributed computing system may use a binary min-heap as the second data structure, and may restrict the maximum size of the binary min-heap to a value, X, which correlates to the amount of storage space available in the higher performance storage devices. The example system could then store a list of references to the most frequently used data chunks, up to X data chunks, in the binary min-heap in order to determine which data chunks should be moved to or from the higher performance storage devices.

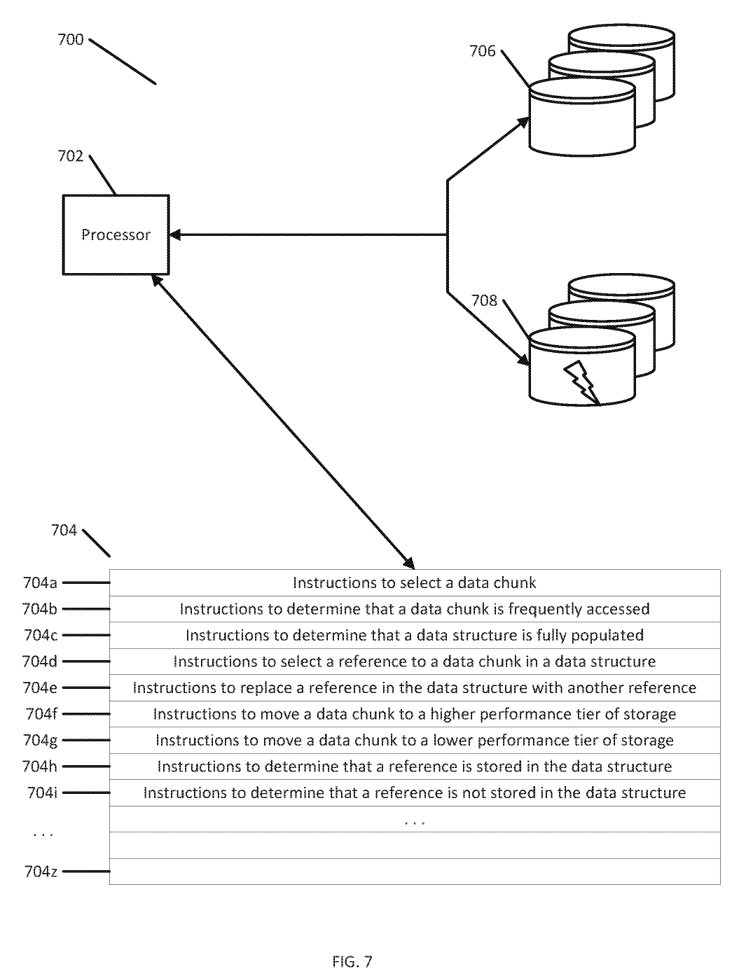

In the example shown in FIG. 1, a method is illustrated for moving frequently accessed data chunks to a storage device. Although execution of the methods of FIGS. 1-4B are described in relation to system 700 of FIG. 7, it is contemplated that the methods of FIGS. 1-4B may be executed on any suitable system or devices. The methods of FIGS. 1-4B may be implemented as processor-executable instructions stored on a non-transitory, computer-readable medium or in the form of electronic circuitry. The specific sequences of operations described in relation to FIGS. 1-4B are not intended to be limiting, and implementations not containing the particular orders of operations depicted in FIGS. 1-4B may still be consistent with the examples shown in FIGS. 1-4B.

In FIG. 1, processor 702 of FIG. 7 may execute the method beginning at block 100 by selecting a data chunk from a number of data chunks that are stored in a first tier of storage. The first tier of storage is a group of storage devices that has lower performance as compared to a second tier of storage. For example, the first tier of storage may have increased latency and decreased throughput as compared to the second tier of storage. Although the first tier of storage and the second tier of storage may each respectively include homogeneous storage devices, in some examples the first tier of storage may include a number of heterogeneous storage devices which have a performance characteristic that is below a performance threshold. Similarly, in some examples the second tier of storage may include a number of heterogeneous storage devices which have a performance characteristic that is above a performance threshold. The data chunk may be selected iteratively or based on an event. For example, each data chunk may be selected upon consecutive iterations of the method of FIG. 1. In some examples, a data chunk may be selected upon receipt of a read request or a write request for the data chunk.

In block 102, the data chunk is determined to be frequently accessed or not frequently accessed. In some examples, an access count is calculated for the data chunk and the access count is compared to an access threshold. If the access count exceeds the access threshold, then the data chunk may be determined to be frequently accessed. If the access count does not exceed the access threshold, then the data chunk may be determined to be not frequently accessed. For example, the access count for the data chunk may be calculated using hash functions to retrieve a number of access count values from a count-min sketch. The access count may then be obtained by determining the minimum access count value retrieved from the count-min sketch. In some examples, the count-min sketch includes a two-dimensional array with Y rows and X columns. X and Y are predetermined numbers that correlate to a probability of error of the access count. In some examples, the access count can overcount the number of accesses to the data chunk based on the probability of error, but the access count does not undercount the number of accesses to the data chunk. As a result, frequently accessed data chunks will always be identified, with a chance of not frequently accessed data chunks being improperly identified as frequently accessed.

If the data chunk is determined to be frequently accessed, the method of FIG. 1 continues to block 104. In block 104, a reference to the data chunk is inserted into a data structure. In some examples, the data structure contains a binary min-heap which inserts the reference based on the access count of the data chunk. An example binary min-heap includes a list of frequently accessed data chunks. The list of frequently accessed data chunks may be arranged in a binary tree such that the root of the tree contains a reference to the data chunk with the lowest access count of the frequently accessed data chunks.

In block 106, it is determined whether the reference to the data chunk is stored in the data structure. In some examples, block 106 is executed periodically based on an elapsed time or based on an event trigger. For example, a timer may expire, resulting in block 106 executing. In some examples, the system iterates through each node of the binary min-heap and compares the reference stored in each node to the selected data chunk.

In block 108, upon determining that the reference to the data chunk is stored in the data structure, the system may move the data chunk to higher performance storage. For example, the data chunk, which may be located in the first tier of storage, may be moved to a storage device in the second tier of storage. In some examples, a portion of free storage on a second tier device may be reserved for the data chunk, and the system may then move the data from the first tier to the portion of free storage. In some examples, the portion of storage from the first tier that had held the data chunk may be freed.

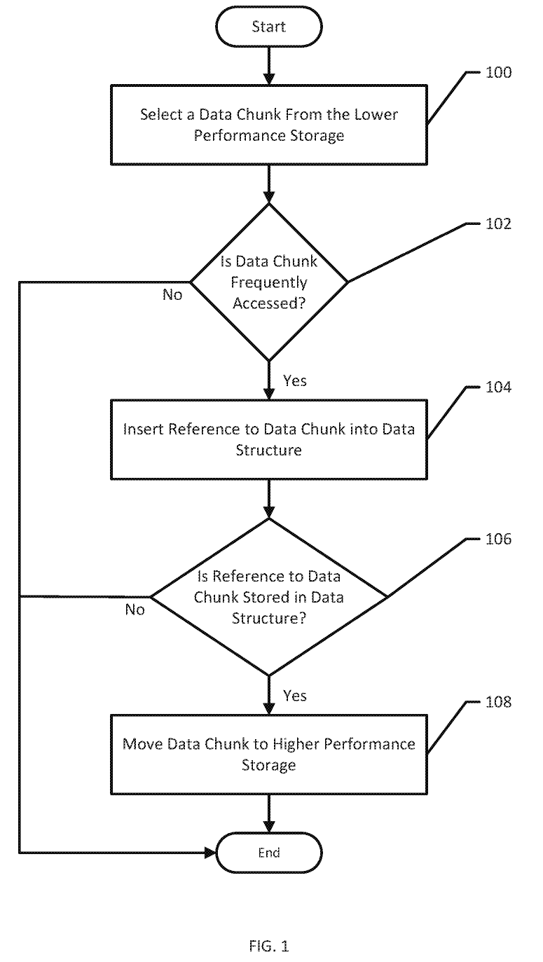

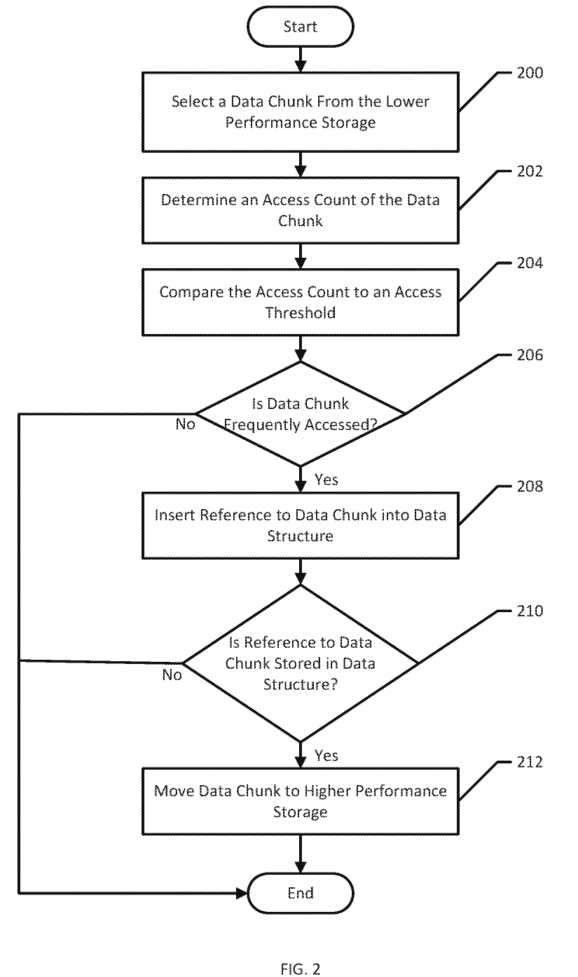

In FIG. 2, processor 702 of FIG. 7 may execute the method beginning at block 200 by selecting a data chunk from a number of data chunks that are stored in the first tier of storage as described in reference to block 100 of FIG. 1 above.

In block 202, an access count may be determined for the data chunk. In some examples, the access count is determined based on determining a minimum of a number of access count values stored in a count-min sketch. The access count values may each be stored in a respective row of the count-min sketch such that the result of a hash function is a column of the respective row where an access count value for the data chunk is stored. In some examples, each row of the count-min sketch may have an associated hash function that receives a reference to a data chunk and results in a column of the row containing the access count value of the data chunk. For example, a system containing a count-min sketch with three rows may have three corresponding hash functions, and the data chunk may have three access count values, each associated with one of the three rows. In some examples, all of the access count values for the data chunk may be compared, and the minimum access count value. is identified as the access count of the data chunk.

In block 204, the access count of the data chunk is compared to an access threshold. For example, an access threshold may be determined based on characteristics of an example distributed computing system.

In some examples, the resulting determination from block 204 may be used in block 206 to determine whether the data chunk is frequently accessed. For example, if the access count of the data chunk exceeds an access threshold, the data chunk may be determined to be frequently accessed. Similarly, if the access count of the data chunk is exceeded by an access threshold, the data chunk may be determined to be not frequently accessed.

In block 208, a reference to the data chunk is inserted into a data structure as described in reference to block 104 of FIG. 1 above.

In block 210, it is determined whether the reference to the data chunk is stored in the data structure as described in reference to block 106 of FIG. 1 above.

In block 212, upon determining that the reference to the data chunk is stored in the data structure, the system may move the data chunk to higher performance storage as described in reference to block 108 of FIG. 1 above.

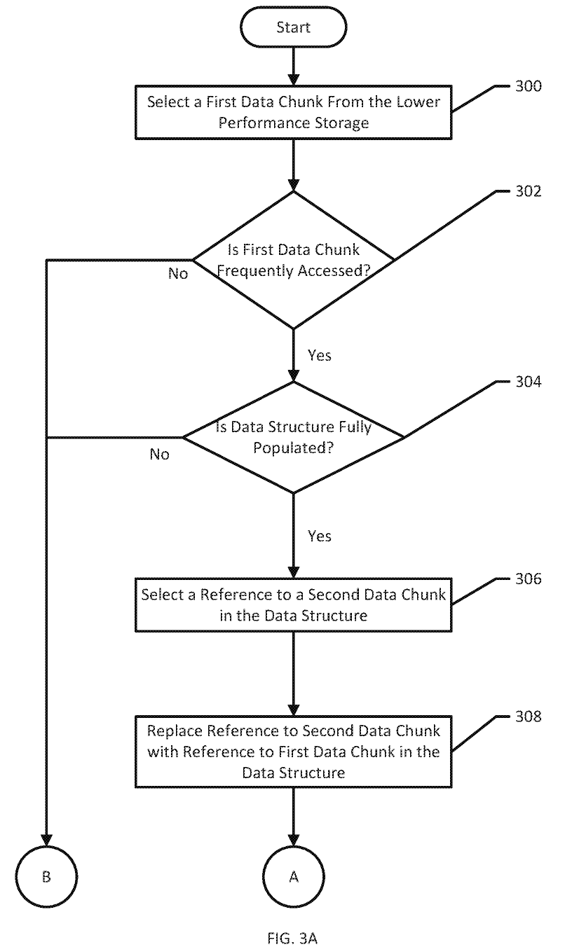

In FIG. 3A, processor 702 of FIG. 7 executes the method beginning at block 300 by selecting a first data chunk from a number of data chunks that are stored in the first tier of storage as described in reference to block 100 of FIG. 1 above.

In block 302, the first data chunk is determined to be frequently accessed or not frequently accessed as described in reference to block 102 of FIG. 1 above. If the first data chunk is determined to be not frequently accessed, the method proceeds to block B. If the first data chunk is determined to be frequently accessed, the method proceeds to block 304.

In block 304, it is determined whether a data structure is fully populated. In some examples, the data structure may contain a binary min-heap which includes a list of frequently accessed data chunks. The binary min-heap may have a maximum size based upon the number of data chunks that can be stored in second tier storage. For example, a binary min-heap with a maximum size of five may be used in an example system where the second tier storage has the capacity to store five data chunks. In some examples, the data structure is fully populated when every node in a binary tree of the binary min-heap is populated with a reference to a frequently accessed data chunk. If the data structure is not fully populated, the method proceeds to block B. If the data structure is fully populated, the method proceeds to block 306.

In block 306, a reference to a second data chunk is selected from the data structure. In some examples, the reference selected is the root of the binary tree included in the binary min-heap. The binary min-heap may be sorted by access count of the frequently accessed data chunks such that the root of the binary tree is the lowest access count of the frequently accessed data chunks. An example system may select the reference to the data chunk with the lowest access count in the binary min-heap.

In block 308, the reference to the second data chunk is replaced with a reference to the first data chunk. In some examples, replacing the reference to the second data chunk includes removing the reference from a node of a binary tree of the data structure and running an algorithm to place the remaining references appropriately within the binary tree. For example, if the reference to the second data chunk is located in the root node of the binary tree and the data structure is a binary min-heap, a heap algorithm may execute to place the reference with the lowest access count, exempting the reference to the second data chunk, in the root node. In some examples, the reference to the first data chunk is inserted into the binary tree prior to executing the heap algorithm. In some examples, the reference to the first data chunk is inserted into the binary tree at a specific node after a first heap algorithm executes and before a second heap algorithm executes.

Block A of FIG. 3A corresponds to block A of FIG. 3B. Block B of FIG. 3A corresponds to block B of FIG. 3B. Therefore, the method of FIG. 3B is a continuation of the method of FIG. 3A.

In FIG. 3B, the method continues from block A with block 310. In block 310, it is determined whether the reference to the first data chunk is stored in the data structure as described in reference to block 106 of FIG. 1 above. In block 312, it is determined whether the reference to the second data chunk is stored in the data structure as described in reference to block 106 of FIG. 1 above.

In block 314, upon determining that the reference to the first data chunk is stored in the data structure, the system may move the first data chunk to higher performance storage as described in reference to block 108 of FIG. :1. above,

In block 316, upon determining that the reference to the second data chunk is not stored in the data structure, the system may move the second data chunk to lower performance storage. In some examples, blocks 314 and 316 may be executed in parallel such that the first data chunk is moved to the portion of higher performance storage previously occupied by the second data chunk and the second data chunk is moved to the portion of lower performance storage previously occupied by the first data chunk.

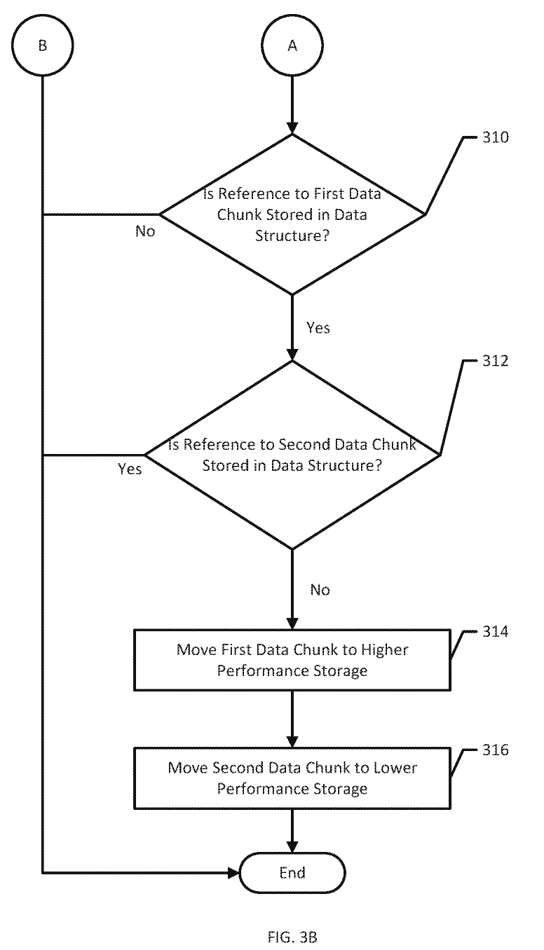

In FIG. 4A, processor 702 of FIG. 7 executes the method beginning at block 400 by selecting a first data chunk from a number of data chunks that are stored in the first tier of storage as described in reference to block 100 of FIG. 1 above.

In block 402, an access count is determined for the first data chunk as described in reference to block 202 of FIG. 2 above.

In block 404, the access count of the first data chunk is compared to an access threshold as described in reference to block 204 of FIG. 2 above.

In block 406, the resulting determination from block 404 may be used to determine whether the first data chunk is frequently accessed as described in block 206 of FIG. 2 above.

In block 408, it is determined whether a data structure is fully populated as described in reference to block 304 of FIG. 3A above.

In block 410, a reference to a second data chunk is selected from the data structure as described in reference to block 306 of FIG. 3A above.

In block 412, the reference to the second data chunk is replaced with a reference to the first data chunk as described in reference to block 308 of FIG. 3A above.

Block A of FIG. 4A corresponds to block A of FIG. 4B. Block B of FIG. 4A corresponds to block B of FIG. 4B. Therefore, the method of FIG. 4B is a continuation of the method of FIG. 4A.

In FIG. 4B, the method continues from block A with block 414. In block 414, it is determined whether the reference to the first data chunk is stored in the data structure as described in reference to block 106 of FIG. 1 above. In block 416, it is determined whether the reference to the second data chunk is stored in the data structure as described in reference to block 106 of FIG. 1 above.

In block 418, upon determining that the reference to the first data chunk is stored in the data structure, the system may move the first data chunk to higher performance storage as described in reference to block 108 of FIG. 1 above.

In block 420, upon determining that the reference to the second data chunk is not stored in the data structure, the system may move the second data chunk to lower performance storage as described in reference to block 316 of FIG. 3B.

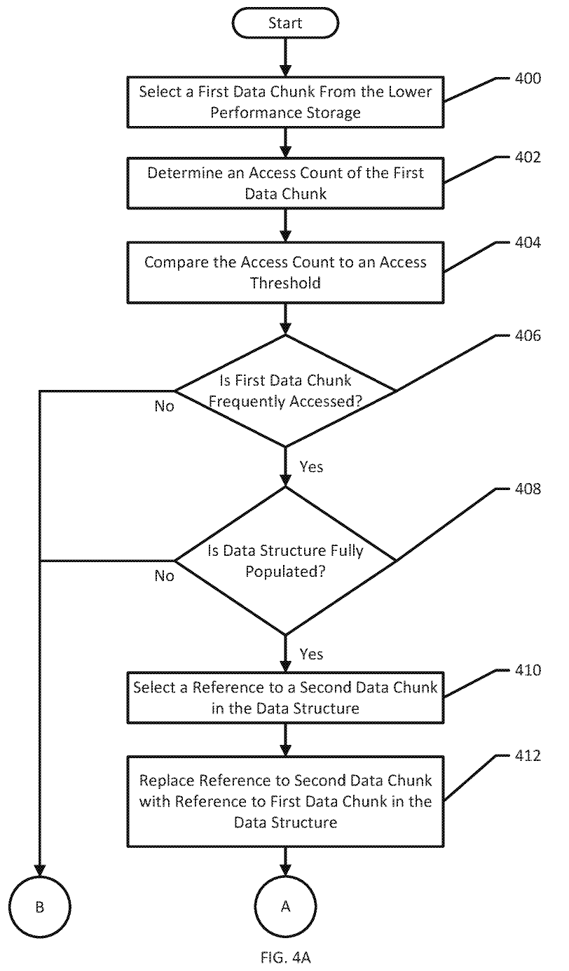

In FIG. 5, an example system for storing access counts of data chunks is described. The example system is stored within memory 500 and includes two-dimensional array 504 including rows 510, 530, 550 and columns 520, 540, 560. In some examples, two-dimensional array 504 is included in a count-min sketch, and the dimensions of two-dimensional array 504 are calculated to limit a probability of error of the access count of a data chunk. Each element of two-dimensional array 504 contains an access count value (e.g. access count values 5210, 5430, 52Y) referenced by row and column.

In an example system, processor 500 executes instructions from memory 500 to obtain data chunk reference 566 from storage 564 and input data chunk reference 566 into hash functions 562. In some examples, each hash function 562 is iterated through based on an input row 568. Each hash function 562 outputs a corresponding column 570. Using input row 568 and corresponding column 570, an example count-min sketch may identify an access count value from two dimensional array 504. As each row is iterated through and input as input rows 568, a number of corresponding columns 570 may be output from hash functions 562, and an example count-min sketch may identify a number of access count values for a data chunk.

Once a number of access count values are identified for a data chunk, an access count may be calculated for the data chunk by determining the minimum access count value. In some examples, the access count values may not accurately capture the number of accesses to the data chunk. The access count values may overcount the number of accesses to the data chunk by a probability of error, but does not undercount the number of accesses. For example, in the count-min sketch, a first data chunk may be hashed to column 540 in row 510 and to column 520 in row 530, and access count values 5410 and 5230 may correspond to the first data chunk. A second data chunk may also be hashed to column 540 in row 510 and to column 560 of row 530, and access count values 5410 and X30 may correspond to the second data chunk. The hash collision between the first data chunk and the second data chunk in row 510 may result in access count value 5410 overcounting the accesses to the first data chunk and accesses to the second data chunk. However, since there is no hash collision between the first data chunk and the second data chunk in row 530, access count values 5230 and X30 may overcount the respective accesses to the first data chunk and the second data chunk by less than access count value 5410. By determining the minimum of access count value, the overcount of the number of accesses of the data chunk may be minimized, which may reduce the number of false positives when determining the frequently accessed data chunks.

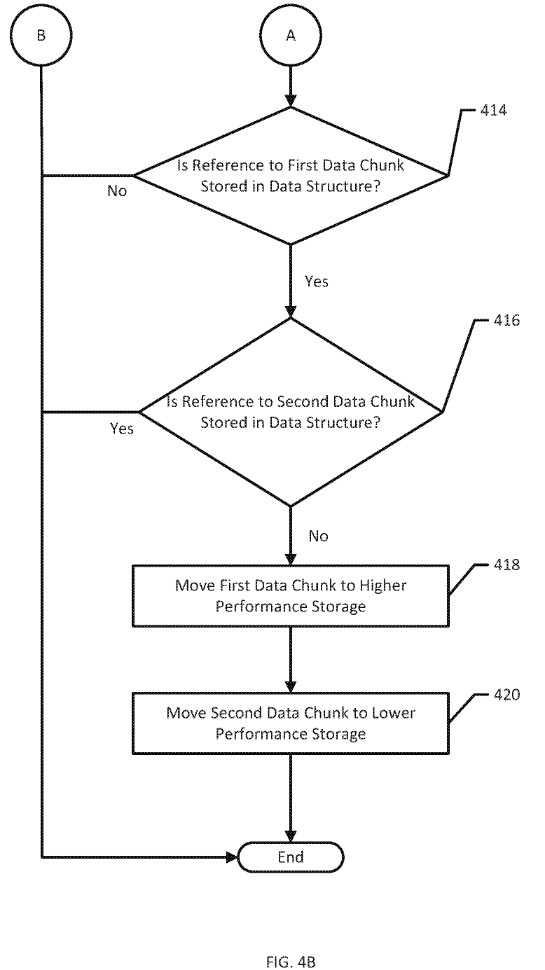

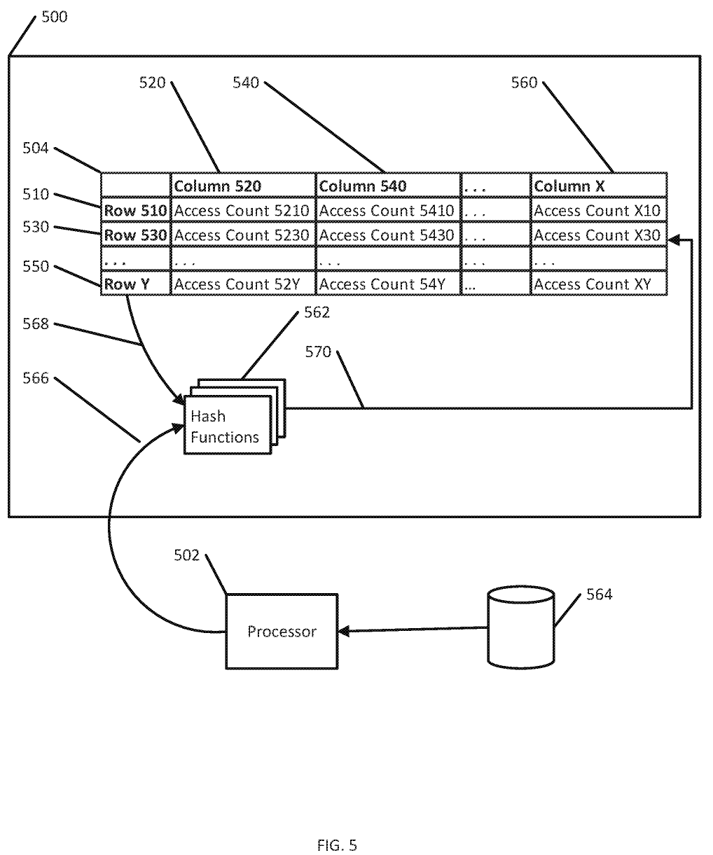

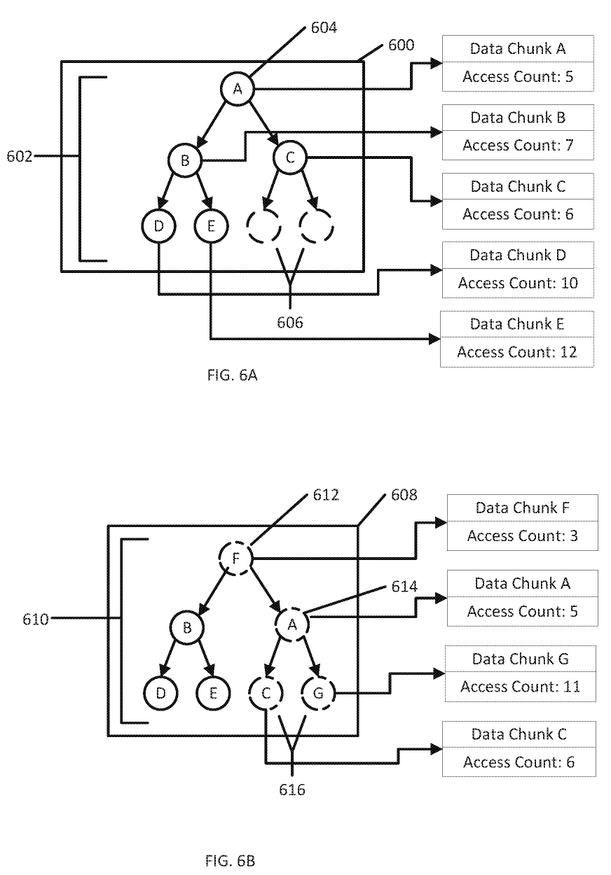

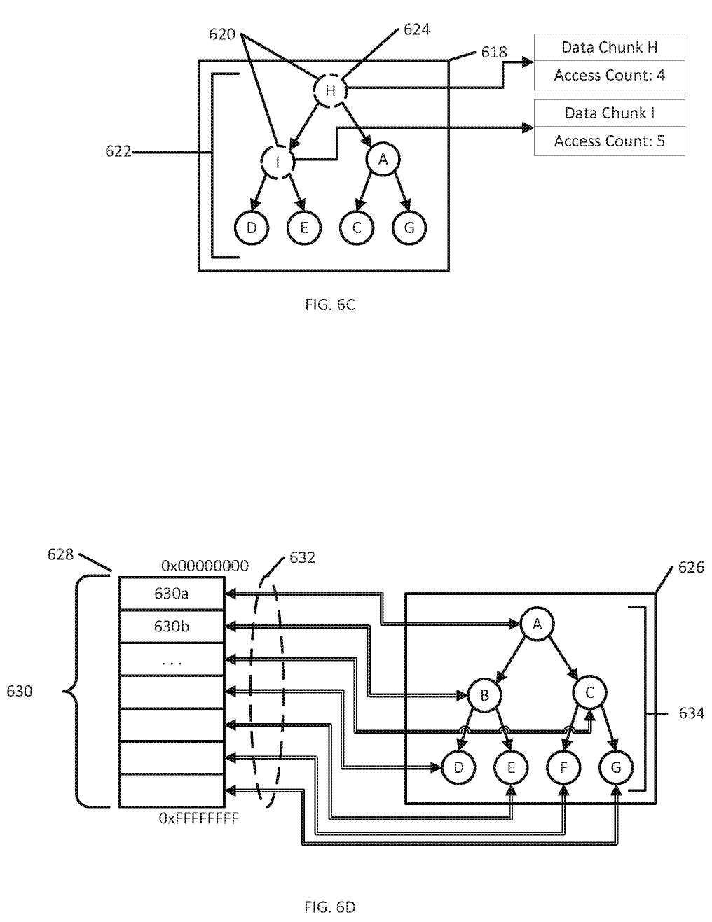

In FIG. 6A, an example data structure is illustrated for storing a list of frequently accessed data chunks. In some examples, binary min-heap 600 is contained in memory 704 of FIG. 7. In some examples, binary min-heap 600 contains a binary tree, which includes nodes 602. In FIG. 6A, Nodes 602 contain references to frequently accessed data chunks A, B, C, D, and E. Root node 604 contains a reference to data chunk A, which has the fewest accesses of the frequently accessed data chunks. In some examples, each node 602 of binary min-heap 600 has fewer accesses than any of its children. However, the children of a node 602. have no specific relation to one another. For example, data chunk B and data chunk C each may have a higher access count than data chunk A, but data chunk B may have a higher access count or a lower access count than data chunk C. Binary min-heap 600, as shown in FIG. 6A, is not fully populated, and contains empty nodes 606. Empty nodes 606 do not contain references to data chunks, but since binary min-heap 600 is a fixed size data structure, empty nodes 606 are not removed from binary min-heap 600. In the example shown in FIG, 6A, the maximum size of binary min-heap 600 is seven data chunks, which corresponds to a second tier of storage containing enough storage for seven data chunks. For example, if a data chunk is defined as 500 MB in size, and the second tier of storage contains 3.50 GB, binary min-heap 600 may store seven data chunks, which corresponds to 3.50 GB of data. As shown in the example of FIG. 6A, nodes 602 contain references to data chunks A, B, C, D, and E, and are sorted by the access count of the respective data chunk. In some examples, a reference to data chunk A is stored in root node 604 because data chunk A's access count (shown as 5 in FIG. 6A) is lower than the access counts of any other data chunk with a reference in binary min-heap 600.

In the example of FIG. 6B, references to data chunks F and G are inserted into binary min-heap 608. Upon insertion of a reference to a data chunk, nodes 610 may be rearranged to preserve the sorting of binary min-heap 608, particularly that a parent node has a lower access count than its children. Nodes 610 may be rearranged using a heap algorithm. Root node 612 contains a reference to data chunk F, and child node 614 contains a reference to data chunk A, which was contained in root node 604 in FIG. 6A. Formerly empty nodes 616 are now populated with references to data chunks C and G. Binary min-heap 608 is fully populated since each node 610 contains a reference to a data chunk. In some examples, the insertion of a reference may include writing a value to an address in memory 704 of FIG. 7. In an example shown in FIG. 6B, the inserted references are to data chunk F and data chunk G, which have three and eleven accesses, respectively. As such, the reference to data chunk F resides in root node 6:12 since it contain the lowest access count of any data chunk referenced in binary min-heap 608.

The example of FIG. 6C illustrates when references to data chunks H and I have been inserted into the fully populated binary min-heap 608 of FIG. 6B. Inserted references 620 replace nodes with lowest access counts. For example, if data chunks H and I each have higher access counts than both of data chunks F and B, data chunks H and I may replace data chunks F and B in binary min-heap 618. Like in the example of FIG. 6B, nodes 622 may be rearranged to preserve the sorting of binary min-heap 618 after the insertion of each of data chunks H and I. In some examples, FIG, 6C illustrates that nodes 622 have been rearranged after the insertion of data chunk H, and data chunk H is contained in root node 624 due to having the lowest access count of the frequently accessed data chunks. In certain examples, FIG. 6C illustrates that nodes 622 have not been rearranged after the insertion of data chunk H, and data chunk H is contained in root node 624 due to replacing data chunk F, which was contained in root node 612 in FIG, 6B. The heap algorithm, when run, may compare the access count of data chunk H to the access counts of its children, data chunks I and A. In some examples, replacing a reference may include writing a value to an address in memory 704 of FIG. 7 that previously held a reference to a data chunk.

In the example of FIG. 6D, a relation is shown between binary min-heap 626 and second tier storage 628. Second tier storage 628 contains a number of data chunks 614 ranging from storage address 0x00000000 to 0xFFFFFFFF. For example, if one storage address represents a byte, each data chunk 630a, 630b, etc. is 614 MB for a total second tier storage capacity of 4.29 GB. Reference relations 632 illustrate the connection between the references stored in nodes 634 and data chunks 630. For example, each node 634a, 634b, etc. of a fully populated binary min-heap 626 corresponds to a data chunk 630a, 630b, etc. of second tier storage 628 such that every data chunk 630a, 630b, etc. has a corresponding node 634a, 634b, etc. Although reference relations 632 are illustrated in FIG. 6D as corresponding to data chunks 630 in a certain order, a certain node 634a does not directly correspond to a certain data chunk 630a, since a reference to a data chunk 630a may move from a first node 634a to a second node 634b. In some examples, reference relations 632 may be memory pointers that are stored in memory 704 of FIG. 7.

In the example of FIG. 7, a system 700 consists of processor 702 coupled to memory 704, which contains processor-executable instructions 704a, 704b, etc. Instruction 704a, when executed on processor 702, accesses a data chunk stored in first tier storage 706. Instruction 704f moves a data chunk to higher performance second tier storage 708. In accordance with some of the examples in reference to the previous figures, frequently accessed data chunks may be moved from first tier storage 706 to second tier storage 708, For example, instructions 704a-z, when executed on processor 702, may execute a method in accordance with this disclosure, which results in a frequently accessed data chunk moving from first tier storage 706 to second tier storage 708,

In some examples, instructions 704a-z execute blocks from the method of FIGS. 3A-B. For example, instruction 704a may be described in more detail by block 300 of FIG. 3A. Instruction 704b may be described in more detail by block 302 of FIG. 3A. Instruction 704c may be described in more detail by block 304 of FIG. 3A. Instruction 704d may be described in more detail by block 306 of FIG. 3A. Instruction 704e may be described in more detail by block 308 of FIG. 3A. Instruction 704f may be described in more detail by block 314 of FIG, 3B, Instruction 704g may be described in more detail by block 316 of FIG. 3B. Instruction 704h may be described in more detail by block 310 of FIG, 3B. Instruction 704i may be described in more detail by block 312 of FIG. 3B.

Although the example of FIG. 7 discloses a certain system 700, this disclosure contemplates any number and combination of devices and any system 700 capable of operation in accordance with this disclosure. The details included in examples contained in this disclosure are not limiting, and certain examples may be practices without some or all of these details. Some examples may include modifications and variations from the details discussed above. It is intended that the appended claims cover such modifications and variations.

1. A method comprising:
selecting a first data chunk residing in a first tier of storage;
in response to determining that the first data chunk is frequently accessed, inserting a reference to the first data chunk into a data structure including a list of frequently accessed data chunks; and
in response to determining that the reference to the first data chunk is stored in the data structure, moving the first data chunk to a second tier of storage wherein the second tier of storage has higher performance than the first tier of storage.

2. The method of claim 1, wherein determining that the first data chunk is frequently accessed comprises comparing an access count of the first data chunk to an access threshold.

3. The method of claim 2, wherein the access count of the first data chunk is determined by identifying a minimum value of a plurality of values retrieved from a two-dimensional array.

4. The method of claim 3, wherein the two-dimensional array comprises a count-min sketch and each of the plurality of values is retrieved from a respective row of the count-min sketch by applying a hash function corresponding to the respective row.

5. The method of claim 1, wherein the list of frequently accessed data chunks is sorted by an access count of each data chunk.

6. The method of claim 1, wherein a maximum size of the data structure corresponds to a number of data chunks that fully populate the second tier of storage.

7. The method of claim 1, wherein the data structure comprises a binary min-heap.

8. A non-transitory computer-readable medium comprising processor-executable instructions that, when executed cause a processor to:
select a first data chunk residing in a first tier of storage, wherein a second tier of storage has higher performance than the first tier of storage;
in response to determining that the first data chunk is frequently accessed and a data structure including a list of frequently accessed data chunks is fully populated:
select a reference in the data structure to a second data chunk; and
replace the reference to the second data chunk with a reference to the first data chunk; and
in response to determining that the reference to the first data chunk is being stored in the data structure and the reference to the second data chunk is not being stored in the data structure:
move the first data chunk to the second tier of storage; and
move the second data chunk from the second tier of storage to the first tier of storage.

9. The non-transitory computer-readable medium of claim 8, wherein the instructions further comprise instructions executable to determine that the first data chunk is frequently accessed, wherein the instructions to determine comprise instructions to compare an access count of the first data chunk to an access threshold.

10. The non-transitory computer-readable medium of claim 9, wherein the instructions to compare further comprises instructions to identify a minimum value of a plurality of values retrieved from a two-dimensional array to determine the access count of the first data chunk.

11. The non-transitory computer-readable medium of claim 10, wherein the two-dimensional array comprises a count-min sketch and each of the plurality of values is retrieved from a respective row of the count-min sketch by applying a hash function corresponding to the respective row.

12. The non-transitory computer-readable medium of claim 8, wherein the list of frequently accessed data chunks is sorted by an access count of each data chunk.

13. The non-transitory computer-readable medium of claim 12, wherein the data structure is fully populated when the data structure contains references to a plurality of data chunks that fully populate the second tier of storage.

14. The non-transitory computer-readable medium of claim 8, wherein the instructions comprise instructions to determine that the reference to the first data chunk is being stored in the data structure and the reference to the second data chunk is not being stored in the data structure based on a periodic scan of the data structure.

15. A distributed computing system comprising:
a processor;
a first plurality of storage devices coupled to the processor;
a second plurality of storage devices coupled to the processor, the second plurality of storage devices having higher performance than the first plurality of storage devices; and
a memory comprising instructions executable by the processor to:
in response to detecting an access to a first data chunk of the first storage devices, increment a plurality of values of a two-dimensional array;
determine an access count of the first data chunk by identifying a minimum value of the plurality of values of the two-dimensional array;
determine whether the first data chunk is frequently accessed by comparing an access threshold to the access count of the first data chunk;
in response to determining that the first data chunk is frequently accessed, insert a reference to the first data chunk into a data structure including a list of frequently accessed data chunks;
determine whether the reference to the first data chunk is stored in the data structure; and
in response to determining that the reference to the first data chunk is being stored in the data structure, move the first data chunk to the second storage devices.

16. The system of claim 15, wherein each of the plurality of values of the two-dimensional array is associated with a corresponding row of the two-dimensional array.

17. The system of claim 16, wherein incrementing the plurality of values comprises applying a hash function to determine a corresponding column of the two-dimensional array for each of the plurality of values.

18. The system of claim 17, wherein determining the access count of the first data chunk comprises applying the hash function to determine the corresponding column of the two-dimensional array for each of the plurality of values.

19. The system of claim 15, wherein the list of frequently accessed data chunks is sorted by an access count of each data chunk.

20. The system of claim 15, wherein a maximum size of the data structure corresponds to a number of data chunks that fully populate the second plurality of storage devices.
